(19) United States
(12) Patent Application Publication
(10) Pub. No.: US 2008/0167422 A1
(43) Pub. Date: Jul. 10, 2008

(54) Polypropylene-containing flame retardant resin formulation and insulated electrical wire coated with the same formulation

(75) Inventor: Hiroshi Hashimoto, Susono-Shi (JP)

Correspondence Address: Edwards Angell Palmer & Dodge LLP, 1875 Eye Street, NW, Washington, DC, 20006, US

(73) Assignee: Yazaki Corporation, Tokyo (JP)

(21) Appl. No.: 11/987,357

(22) Filed: Nov. 29, 2007

(30) Foreign Application Priority Data
Jan. 10, 2007 (JP) 2007-002372

(51) Int. Cl. C08L 23/12

(52) U.S. Cl. 524/584

(57) ABSTRACT

The present invention is intended to provide halogen-free propylene-containing flame retardant resin formulations having high levels of impact resistance. More particularly, the present invention is intended to provide a halogen-free propylene-containing flame retardant resin formulation which is excellent in mechanical properties such as tensile strength, flexibility, low temperature flexural properties, chemical resistance, heat resistance and abrasion resistance, and an electrical wire having insulation coating formed of the same halogen-free propylene-containing flame retardant resin formulation and having high levels of impact resistance.

The afore-mentioned object can be achieved by a polypropylene-containing flame retardant resin formulation having viscoelastic property value tan δ of greater than or equal to 0.1 at 25° C., for a frequency of 1 to 30 Hz, and type D durometer hardness of 68 to 74, comprising a base resin composition comprising 65 to 90 parts by weight of polypropylene, and 10 to 35 parts by weight of at least one component selected from the group consisting of polyethylene-based resins, olefin-based thermoplastic elastomers, and styrene-based thermoplastic elastomers, based on the total parts by weight of the base resin composition, and 60 to 100 parts by weight of an inorganic flame retardant additive, based on the total parts by weight of the base resin composition.

### CROSS-REFERENCE TO RELATED APPLICATIONS

The present application claims priority to Japanese Patent Application No. 2007-2372 filed Jan. 10, 2007, the entire disclosure of which is expressly incorporated herein by reference.

### BACKGROUND OF THE INVENTION

(1) Field of the Invention

The present invention relates to a propylene-containing flame retardant resin formulation having high levels of impact resistance, and more particularly, a polypropylene-containing flame retardant resin formulation which is excellent in mechanical properties such as tensile properties, flexibility, low-temperature flexural properties, chemical resistance, heat resistance, and abrasion resistance, and does not emit toxic gases such as halogen-containing gas during the combustion thereof. The present invention also relates to an insulated electrical wire having an insulation coating formed of the afore-mentioned polypropylene-containing flame retardant resin formulation and having high levels of impact resistance.

(2) Description of the Related Art

Since polypropylene has been commercially available at low cost, and is excellent in mechanical strength, heat resistance, chemical resistance, fabrication performance, and recycling performance, it has been widely used in a vast variety of applications such as vehicles, electronics, wrapping materials, and so on.

Meanwhile, polypropylene-based resins are vulnerable to flame, and therefore, when used in specific applications where flame retarding properties is required, they have to be blended with a variety of flame retardant additives.

Further, in view of the concern for possible environmental damage, polypropylene-based resins that do not generate toxic gases during its combustion are desired.

Currently most used halogen-free flame retardant resin formulations comprise base resin composition consisting of polypropylene, and polyolefin-based resins or thermoplastic elastomers. The base resin composition may be blended with metal hydroxides as non-halogen flame retardant additives.

However, to achieve the same level of flame retarding ability as halogen-containing flame retardant resin formulation, metal hydroxide ingredient had to be added in large amounts to the base resin composition. Due to metal hydroxide added in large amounts, the final product formed from the halogen-free flame retardant resin formulation did not provide the requisite flexibility, low temperature flexural properties, and mechanical properties such as tensile strength and the elongation at break. Accordingly, to improve the afore-mentioned mechanical properties, etc in the conventional halogen-free flame retardant resin formulation, a broad spectrum of studies have been conducted and therefore a variety of halogen-free flame retardant resin formulations have been proposed. For example, refer to Publication of Japanese Non-Examined Patent Application No. 2003-313377. These halogen-free flame retardant resin formulations can be, for example, employed in the insulation coating of electrical wires.

While such halogen-free flame retardant resin formulations usually meet flame retarding properties, mechanical properties, and abrasion resistance requirements, they are much vulnerable to external impact as compared with halogen-containing flame retardant resin formulations.

Accordingly, the conventional halogen-free flame retardant resin formulations, in particular when used as an insulation coating on an electrical wire, their poor impact resistance as described above has still needed to be improved.

Specifically, in a case where a plurality of insulated electrical wires having metallic terminals at their ends are tied together to prepare a bundle of electrical wires, the insulation coating of the respective electrical wire is often damaged by the metallic terminal. When a plurality of electrical wires, each of which is different from the others in its length and is equipped with a terminal, are tied together to prepare a bundle of electrical wires, for example, during the preparation of a wiring harness, at least one electrical wires are pulled out of the bundle of the electrical wires, which are tied together, if needed.

In this case, the coating layers of the remaining electrical wires are often rubbed with the terminal of the electrical wire(s) to be pulled out (i.e. to be selected), thereby causing the coating layers of the remaining electrical wires to be damaged. As such the currently used coating layer formed of afore-mentioned halogen-free flame retardant resin formulation has a tendency to be significantly damaged, as compared with the coating layer formed of halogen-containing flame retardant resin formulation. The resulting scratches, damages or defects on the coating layer can adversely affect waterproof properties, durability, reliability, and appearance of the bundle of the electrical wires.

Accordingly, the afore-mentioned problems of currently used halogen-free flame retardant resin formulations have needed to be improved in the art for a long period of time up to now.

### SUMMARY OF THE INVENTION

To solve the afore-mentioned problems, the present invention is intended to provide a halogen-free propylene-containing flame retardant resin formulation having high levels of impact resistance. More particularly, the present invention is intended to provide a halogen-free propylene-containing flame retardant resin formulation which is excellent in mechanical properties such as tensile strength, flexibility, low temperature flexural properties, chemical resistance, heat resistance and abrasion resistance, and an electrical wire having an insulation coating formed of the foregoing halogen-free propylene-containing flame retardant resin formulation and having high levels of impact resistance.

In the first aspect of the present invention, there is provided a polypropylene-containing flame retardant resin formulation having viscoelastic property value tan δ of greater than or equal to 0.1 at 25° C. for a frequency of 1 to 30 Hz, and type D durometer hardness of 68 to 74, which comprises a base resin composition comprising 65 to 90 parts by weight of polypropylene, and 10 to 35 parts by weight of at least one component selected from the group consisting of polyethylene-based resins, olefin-based thermoplastic elastomers, and styrene-based thermoplastic elastomers, based on the total parts by weight of the base resin composition, and 60 to 100 parts by weight of an inorganic flame retardant additive, based on the total parts by weight of the base resin composition.

In the second aspect of the present invention, there is provided an insulated electrical wire to be used in a vehicle, having an insulation coating formed of the polypropylene-containing flame retardant resin formulation in accordance with the first aspect of the present invention as described above.

For the purpose of illustrating the invention, there will be provided following detailed descriptions of certain embodiments of the present invention. It should be understood, however, that the present invention is by no means limited by the embodiments.

### DESCRIPTION OF THE PREFERRED EMBODIMENTS

In a halogen-free polypropylene-containing flame retardant resin formulation in accordance with one embodiment of the present invention, a mixture of 65 to 90 parts by weight of polypropylene, and the remaining parts by weight of at least one component selected from the group consisting of polyethylene-based resins, olefin-based thermoplastic elastomers, and styrene-based thermoplastic elastomers is (are) employed as a base resin composition.

Polypropylene suitable for use in the present invention includes, but is not limited to, a polypropylene block copolymer or a polypropylene homopolymer. For example, such a polypropylene block copolymer is sold under the trademark E-150GK by PRIME POLYMER CO., LTD. located in Japan or the trademark BC8 by NIPPON POLYPRO CO., LTD located in Japan. For example, such a polypropylene homopolymer is sold under the trademark PL400A by SUNALLOMER CO., LTD located in Japan or under the trademark FY6C by NIPPON POLYPRO CO., LTD. located in Japan. Among these polypropylene resins, the polypropylene block copolymer is particularly suitable for providing an electrical wire, in particular, an electrical wire to be used in a vehicle with an insulation coating layer, due to its excellent elasticity, mechanical properties such as tensile rupture, abrasion resistance, flexibility, and so on.

Polyethylene-based resin, olefin-based thermoplastic elastomer, or styrene-based thermoplastic elastomer, which is compatible with the polypropylene component, is added to polypropylene in order to enhance the flexibility, low temperature resistance, etc. of the polypropylene component.

Polyethylene resin suitable for use with the present invention includes, but is not limited to, low density polyethylene. For example, such a low density polyethylene is sold under the trademark 2015M by PRIME POLYMER CO., LTD. located in Japan or under the trademark Novatec LC605Y by NIPPON POLYCHEM CO. LTD. located in Japan. Olefin-based thermoplastic elastomer suitable for use with the present invention includes, but is not limited to, ethylene propylene rubber such as EPM (also called as “EPR”) and EPDM in its soft segment. Styrene thermoplastic elastomer suitable for use with the present invention includes, but is not limited to, copolymer of polystyrene block and polyethylene-polypropylene block, or copolymer of polystyrene block and polyethylene-polybutylene block.

Polyethylene resins, olefin thermoplastic elastomers, or styrene thermoplastic elastomers are employed in amounts ranging from 10 to 35 parts by weight based on the total parts by weight of the base resin composition. In a case where these polyethylene resins, olefin thermoplastic elastomers, or styrene thermoplastic elastomers are employed in amounts of less than 10 parts by weight based on the total parts by weight of the base resin composition, viscoelastic property value tan δ increases, thereby adversely affecting impact resistance. On the other hand, in a case where these polyethylene resins, olefin thermoplastic elastomers, or styrene thermoplastic elastomers are employed in amounts of greater than 35 parts by weight based on the total parts by weight of the base resin composition, flexibility notably increases, thereby causing impact resistance to decrease.

An inorganic flame retardant additive is also added to the afore-mentioned base resin composition. The inorganic flame retardant additive is preferably particulate form. For electrical insulation, magnesium hydroxide or aluminum hydroxide is preferably employed as the inorganic flame retardant additive.

The amount of the inorganic flame retardant additive will range from 60 to 100 parts by weight based on the total parts by weight of the base resin composition. In a case where the inorganic flame retardant additive is employed in amounts of less than 60 parts by weight based on the total parts by weight of the base resin composition, sufficient flame retarding properties can hardly be achieved. On the other hand, in a case where the inorganic flame retardant additive is employed in amounts of greater than 100 parts by weight based on the total parts by weight of the base resin composition, the final product's mechanical strength after molding is significantly lowered. Accordingly, the inorganic flame retardant additive is more preferably employed in amounts ranging from 70 to 90 parts by weight based on the total parts by weight of the base resin composition.

In addition to afore-mentioned ingredients, the polypropylene-containing flame retardant resin formulation in accordance with the present invention may include 0.1˜5 parts by weight of phenolic antioxidant, 0.1˜5 parts by, weight of a copper inhibitor such as hydrazine derivatives, or 0.1˜3 parts by weight of a lubricant such as fatty acid derivatives, based on total parts by weight of the base resin composition.

The polypropylene-containing flame retardant resin formulation in accordance with the present invention undergoes mixing by means of a kneader, a banbury mixer, a roll mixer, and so on. If necessary, the resin formulation may undergo extrusion molding, and thereafter, the product thus obtained may be cut into pellet form.

The polypropylene-containing flame retardant resin formulation in accordance with the present invention should have viscoelastic property value tan δ of greater than or equal to 0.1 at 25° C. for a frequency of 1 to 30 Hz, and type D durometer hardness of 68 to 74.

During the polypropylene-containing flame retardant resin formulation in accordance with the present invention, the resin having viscoelastic property value tan δ (at 25° C. for a frequency of 1 to 30 Hz) of greater than or equal to 0.1 may be employed alone or in combination with other resin(s) that has viscoelastic property value tan δ (at 25° C. for a frequency of 1 to 30 Hz) of less than 0.1, but does not show decreased tan δ value in spite of increased frequency.

The viscoelastic property value tan δ is a value obtained by dividing a loss modulus E″ by a storage modulus E′. The decrease of hardness typically results in the increase of the loss modulus E″ and the decrease of the storage modulus E′ thereby allowing the value of tan δ to increase.

If a material, for example, is deformed and then released, a portion of the stored deformation energy will be returned at a rate which is a fundamental property of the material. That is, the material goes into damped oscillation. A portion of the deformation energy is dissipated in other form. The greater the dissipation, the faster the oscillation dies away. If the dissipated energy is restored, the material will vibrate at its natural resonant frequency. The resonant frequency is related to the modulus (stiffness) of the material. Conclusively, energy dissipation is related to impact resistance. Accordingly, the greater the loss modulus E″, the greater energy is dissipated. That is, the high value of the loss modulus E″ indicates high levels of impact resistance (i.e. damage resistance). The polypropylene-containing flame retardant resin formulation in accordance with the present invention can have high levels of impact resistance by adjusting its type D durometer hardness to the range between 68 and 74 for the maintenance of good abrasion resistance, for example, in electrical wires, and its viscoelastic property value tan δ to a degree of greater than or equal to 0.1.

Prior to the present invention, the foregoing polypropylene-containing flame retardant resin formulation having viscoelastic property value tan δ of greater than or equal to 0.1 at 25° C. for a frequency of 1 to 30 Hz, and type D durometer hardness of 68 to 74 has never been disclosed nor suggested.

A shaped article formed of a flame retardant resin formulation having viscoelastic property value tan δ (at 25° C. for a frequency of 1 to 30 Hz) of less than 0.1 will not have enough impact resistance, and therefore is not well suited to an application such as a coating layer of an electrical wire.

Also, a flame retardant polypropylene resin formulation having type D durometer harness of less than 68 will not provide enough abrasion resistance. On the other hand, a resin formulation having type D durometer harness of greater than 74 is inclined to have viscoelastic property value tan δ of less than 0.1 at 25° C. for a frequency of 1 to 30 Hz, and therefore lacks impact resistance.

The present invention will be more fully understood by reference to the following specific embodiments which are not to be construed as limiting the scope of the present invention but are only for purpose of illustration.

### EXAMPLES

Examples of the polypropylene-containing flame retardant resin formulation in accordance with the present invention and the insulated electrical wire having an insulation coating layer formed of the same polypropylene-containing flame retardant resin formulation will be hereinafter illustrated in detail.

Preparation of Propylene-Containing Flame Retardant Resin Formulation

Examples 1˜5 and Comparative Examples 1˜11 of polypropylene-containing flame retardant resin formulation were respectively prepared by mixing materials 1˜5 as listed in Table 1 in a specified ratio (i.e. part by weight) as listed in Table 2, and agitating the resulting mixture in a sand mixer with a screw (45 mmφ). All the polypropylene-containing flame retardant resin formulation thus obtained were excellent in mechanical properties such as tensile strength, flexibility, low-temperature flexural properties, chemical resistance and heat resistance, and did not generate toxic gas during their combustion. In the tables 2 and 3 below, “Ex” and “Com Ex” represent Example and Comparative Example, respectively.

TABLE 1
Materials for polypropylene-containing flame retardant resin
formulation

| | | |
|---|---|---|
| Material 1 | Polypropylene | PL400A ® (SARTOMER |
| | | CO., LTD.) |
| Material 2 | Polyethylene-based resis | 2015M ®(PRIME POLYMER |
| | | CO., LTD.) |
| Material 3 | Polyolefin-based elastomer | R110E ® (PRIME POLYMER |
| | | CO., LTD) |
| Material 4 | Styrene-based elastomer | S4033 ® (KURARAY |
| | | CO., LTD.) |
| Material 5 | Magnesium hydroxide | KISUMA5A ® (KYOWA |
| | | CHEMICAL INDUSTRY |
| | | CO., LTD.) |

TABLE 2
The composition and hardness of the respective
polypropylene-containing flame retardant resin formulations
(Ex 1~5 and Com Ex 1~11)

| | Composition (part by weight) | | | | | |
|---|---|---|---|---|---|---|
| | Material | Material | Material | Material | Material | Hardness |
| | 1 | 2 | 3 | 4 | 5 | JIS D |
| Ex 1 | 68 | 10 | 15 | 7 | 80 | 70 |
| Ex 2 | 87 | 0 | 8 | 5 | 80 | 73 |
| Ex 3 | 75 | 10 | 10 | 5 | 80 | 71 |
| Ex 4 | 68 | 10 | 15 | 7 | 70 | 68 |
| Ex 5 | 68 | 10 | 15 | 7 | 90 | 72 |
| Com Ex 1 | 68 | 8 | 24 | 0 | 80 | 73 |
| Com Ex 2 | 77 | 9 | 14 | 0 | 80 | 75 |
| Com Ex 3 | 85 | 0 | 5 | 10 | 80 | 66 |
| Com Ex 4 | 80 | 5 | 5 | 10 | 80 | 71 |
| Com Ex 5 | 90 | 0 | 0 | 10 | 80 | 73 |
| Com Ex 6 | 70 | 10 | 15 | 5 | 80 | 71 |
| Com Ex 7 | 80 | 5 | 10 | 10 | 80 | 70 |
| Com Ex 8 | 100 | | | | 80 | 72 |
| Com Ex 9 | | 100 | | | 80 | 56 |
| Com Ex 10 | | | 100 | | 80 | 24 |
| Com Ex 11 | | | | 100 | 80 | 22 |

The Preparation of Insulated Electrical Wires for Evaluation

For evaluation and comparison on several performances and properties of the Examples 1˜5 and Comparative Examples 1˜11 of the polypropylene-containing flame retardant resin formulation as described above, the electrical wires each having insulation coating layer respectively formed of Examples 1˜5 and Comparative Examples 6˜11 of polypropylene-containing flame retardant resin formulations were prepared. In detail, the polypropylene-containing flame retardant formulations of Examples 1˜5 and the Comparative Examples 1˜11 were respectively charged into an extruder, in particular, an extruder for an electrical wire having a diameter of 60 mm, L/D of 24.5, and a FF screw, and then were respectively extruded onto an electric conductor at the speed of 600 mm/min. under a temperature of 230° C. to prepare 10 insulated electrical wires each having an outer diameter of 1.20 mm. Prior to the extrusion of the polypropylene-containing flame retardant resin formulation onto the electric conductor, the electric conductor had an area of 0.3395 mm² and was formed by twisting 7 filaments having a diameter of 0.2485 mm.

TABLE 3
Results obtained from the respective tests for dynamic viscoelasticity,
scrape abrasion resistance, and impact resistance

| | Dynamic | | | | | | | |
|---|---|---|---|---|---|---|---|---|
| | viscoelasticity | | Scrape abrasion | | Impact resistance | | | |
| | tan δ | | resistance | | The number of defects | | | Evaluation |
| | 1 Hz | 30 Hz | No. | Evaluation | Dotted | Linear | Total | Pass |
| Ex 1 | 0.154 | 0.129 | 443 | Pass | 2 | 0 | 2 | Pass |
| Ex 2 | 0.144 | 0.120 | 835 | Pass | 2 | 2 | 4 | Pass |
| Ex 3 | 0.131 | 0.118 | 569 | Pass | 3 | 1 | 4 | Pass |
| Ex 4 | 0.157 | 0.127 | 374 | Pass | 1 | 1 | 2 | Pass |
| Ex 5 | 0.137 | 0.117 | 568 | Pass | 3 | 1 | 4 | Pass |
| Com Ex 1 | 0.111 | 0.099 | 852 | Pass | 9 | 6 | 15 | Fail |
| Com Ex 2 | 0.114 | 0.100 | 1395 | Pass | 7 | 11 | 18 | Fail |
| Com Ex 3 | 0.318 | 0.377 | 94 | Fail | 2 | 2 | 4 | Pass |
| Com Ex 4 | 0.105 | 0.091 | 382 | Pass | 10 | 6 | 16 | Fail |
| Com Ex 5 | 0.091 | 0.083 | 750 | Pass | 8 | 9 | 17 | Fail |
| Com Ex 6 | 0.099 | 0.091 | 468 | Pass | 7 | 5 | 12 | Fail |
| Com Ex 7 | 0.118 | 0.097 | 332 | Pass | 6 | 2 | 8 | Fail |
| Com Ex 8 | 0.045 | 0.093 | 311 | Pass | 9 | 7 | 16 | Fail |
| Com Ex 9 | 0.148 | 0.101 | 27 | Fail | 5 | 1 | 6 | Fail |
| Com Ex 10 | 0.101 | 0.156 | 8 | Fail | 3 | 1 | 4 | Fail |
| Com Ex 11 | 0.106 | 0.238 | 7 | Fail | 3 | 2 | 5 | Fail |

Test Method for Dynamic Viscoelasticity

The foregoing 10 insulated electrical wires each having the insulation coating formed of the polypropylene-containing flame retardant resin formulation were measured for dynamic viscoelasticity. In this test, a tester which was sold under the trademark TRYTEC 2000 by SIMADZU MANUFACTURING CO., LTD. and a tension jig (i.e. a measuring clamper) were used. A plurality of sheets having a thickness of 0.2 mm each was respectively formed of the polypropylene-containing flame retardant resin formulations of the foregoing Examples 1˜5 and Comparative Examples 1˜11. A test specimen having a length of 12 mm, a width of 6 mm, and a thickness of 0.2 mm was prepared from each of a plurality of foregoing sheets. These test specimens were respectively measured for dynamic viscoelasticity at a load of 3.33N under a temperature of 25° C. for a frequency of 1 to 30 Hz and an amplitude of 0.05 mm. The results obtained from this dynamic viscoelasticity test were listed in Table 3.

Test Method for Scrape Abrasion Resistance

The test specimen was subjected to abrasion resistance test at a load of 7N using a piano wire having a diameter of 0.45 mm as a blade in accordance with the blade reciprocation method defined by Japan Automobile Standard Organization (JASO) D611-12-(2). The number of reciprocations made until the blade came in contact with the metal rod was then measured at 4 points per test specimen. In the measurement, the minimum value was recorded as a measurement. Test results were evaluated on a Pass/Fail basis as described below. If the number of reciprocations was more than or equal to 300, the corresponding test specimen was scored as “Pass”, which means that it has sufficient abrasion resistance to be used with a vehicle. On the other hand, if the number of reciprocations was less than 300, the corresponding test specimen was scored as “Fail”, which means that it has insufficient abrasion resistance to be used with a vehicle. This test was carried out to find out the abrasion resistance of the insulated electrical wire to be used with a vehicle under a condition where a vehicle was repeatedly robbed with continuously vibrating for a long period of time.

Test Method for Pulling Out an Electrical Wire

This test (i.e. pulling out an electrical wire) was carried out on the assumption that electrical wires were pulled out during the preparation of a wiring harness to be used with a vehicle.

In detail, 50 electrical wires each having a length of 2 m and copper terminals at their both ends were placed inside a circular pipe having a length of 2 m and a diameter of 70 mm. In this arrangement, one end of the each electrical wires was respectively exposed to external environment up to about 5 cm.

Subsequently, one electrical wire was pulled out from the pipe containing 50 electrical wires, and then the foregoing operation was repeatedly carried out until all the 50 electrical wires were completely pulled out from the pipe. Damages, scratches, defects, etc. on the surface of the electrical wire which was pulled out last was examined with the naked eyes. Test results were evaluated on a Pass/Fail basis and listed in Table 3. If the number of either dotted or linear damages, scratches, or defects on the surface of the electrical wire were less than or equal to 5, the corresponding electrical wire was scored as “Pass”, which means that it has good impact resistance. On the other hand, if the number of either dotted or linear damages, scratches, or defects on the surface of the electrical wire were more than 5, the corresponding electrical wire was scored as “Fail”, which means that it has poor impact resistance.

The test results listed in Table 3 show that the polypropylene-containing flame retardant resin formulations have both high levels of abrasion resistance and impact resistance. Further, according to the test results as listed in Table 3, it proved that viscoelastic property value tan δ merely increased or decreased at a frequency ranging from 1 to 30 Hz. Accordingly, in a case where both viscoelastic property values tan δ at 1 Hz and 30 Hz were greater than or equal to 0.1, the corresponding polypropylene-containing flame retardant resin formulation was considered to have viscoelastic property value tan δ of greater than or equal to 0.1 at 25° C. for a frequency of 1 to 30 Hz.

Hereinafter, the advantageous effects of the polypropylene-containing flame retardant resin formulation in accordance with the present invention will be described.

Since the polypropylene-containing flame retardant resin formulation in accordance with the present invention has viscoelastic property value tan δ of greater than or equal to 0.1 at 2° C. for a frequency of 1 to 30 Hz, and type D durometer hardness of 68 to 74, and comprises base resin composition comprising 65 to 90 parts by weight of polypropylene, and 10 to 35 parts by weight of at least one component selected from the group consisting of polyethylene-based resins, olefin-based thermoplastic elastomers, and styrene-based thermoplastic elastomers, based on the total parts by weight of the base resin composition, and 60 to 100 parts by weight of an inorganic flame retarding additive, based on 100 parts by weight of the base resin composition, the shaped articles formed of the polypropylene-containing flame retardant resin formulation have excellent impact resistance, and therefore maintain their intrinsic functionality for a long period of time.

Since the insulated electrical wire to be used with a vehicle has an insulation coating formed of the foregoing polypropylene-containing flame retardant resin formulation, during the preparation of a wiring harness to be used in a vehicle, the coating layers of the remaining electrical wires in a bundle of electrical wires are kept from being damaged by the metallic terminal of the electrical wire, which is pulled out from the bundle of electrical wires. Accordingly, this insulated electrical wire is well suited in such an application as high level of durability is required. For example, this insulated electrical wire can be efficiently used within an engine box.

Changes and modifications in the specifically described embodiments would come within the scope of the invention, which is intended to be limited only by the scope of the appended claims, as interpreted according to the principles of patent law.

What is claimed is:

1. A polypropylene-containing flame retardant resin formulation having viscoelastic property value tan δ of greater than or equal to 0.1 at 25° C. for a frequency of 1 to 30 Hz, and type D durometer hardness of 68 to 74, comprising:
a base resin composition comprising 65 to 90 parts by weight of polypropylene, and 10 to 35 parts by weight of at least one component selected from the group consisting of polyethylene-based resins, olefin-based thermoplastic elastomers, and styrene-based thermoplastic elastomers, based on the total parts by weight of the base resin composition, and
60 to 100 parts by weight of an inorganic flame retardant additive, based on the total parts by weight of the base resin composition.

2. An insulated electrical wire to be used in a vehicle, having an insulation coating formed of the polypropylene-containing flame retardant resin formulation according to claim 1.
